(19) United States
(12) Patent Application Publication
(10) Pub. No.: US 2016/0189206 A1
(43) Pub. Date: Jun. 30, 2016

(54) MONITORING METHOD AND DEVICE FOR DISPLAY NUMBER OF PICTURES

(71) Applicant: BEIJING GRIDSUM TECHNOLOGY CO., LTD., Beijing (CN)

(72) Inventors: Jibin YANG, Beijing (CN); Yongjian HUANG, Beijing (CN); Fei DAI, Beijing (CN)

(21) Appl. No.: 14/911,812

(22) PCT Filed: Jul. 31, 2014
(86) PCT No.: PCT/CN2014/083453

§ 371 Date: Feb. 12, 2016

(30) Foreign Application Priority Data
Aug. 13, 2013 (CN) 201310351665.2

(51) Int. Cl. G06Q 30/02

(52) U.S. Cl. CPC G06Q 30/0246

(57) ABSTRACT

The disclosure discloses a method and device for monitoring the number of displays of a picture. The method includes: acquiring a target picture; adding a parameter representative of display information of target picture; and monitoring the number of times calling the parameter to obtain the number of displays of the target picture in a webpage. By the disclosure, the problem of incapability of monitoring an advertisement in a picture form in an existing technology is solved, and the effect of making a statistic on the number of displays of an advertisement picture is further achieved.

### TECHNICAL FIELD OF THE INVENTION

The disclosure relates to the field of data processing, and in particular to a method and device for monitoring the number of displays of a picture.

### BACKGROUND OF THE INVENTION

For monitoring of an advertisement delivered by an advertiser in an existing technology, it is necessary to modify a Flash and add a monitoring code to implement monitoring of an advertisement which is displayed in a Flash form, but an advertisement in a picture form may not be monitored. The advertiser refers to an advertisement publisher, a merchant selling or propagandizing own product and service on the Internet and a provider of an affiliate marketing advertisement. Any merchant propagandizing and selling own product or service may be an advertiser. An advertiser publishes an advertisement and pays a website master according to the total number of marketing effects and unit effect price specified in the advertisement completed by the website master. Display is also called impression, and refers to the number of audiences seeing an advertisement which is delivered in a certain medium by a brand advertiser. For example, a user seeing an automobile advertisement makes a contribution to a display (impression) of the advertisement when accessing a certain site.

For the problem of incapability of monitoring an advertisement in a picture form in a related technology, there is yet no effective solution.

### SUMMARY OF THE INVENTION

A main purpose of the embodiment of the disclosure is to provide a method and device for monitoring the number of displays of a picture, so as to solve the problem of incapability of monitoring an advertisement in a picture form in the existing technology.

According to one aspect of the embodiment of the disclosure, a method for monitoring the number of displays of a picture is provided, which includes: acquiring a target picture; adding a parameter representative of display information of the target picture; and monitoring the number of times calling the parameter to obtain the number of displays of the target picture in a webpage.

Preferably, after adding the parameter representative of the display information of the target picture, the method further includes: controlling the parameter to generate an Identifier (ID) of the target picture, wherein monitoring the number of times calling the parameter to obtain the number of displays of the target picture in the webpage includes: monitoring the number of times calling the ID to obtain the the number of displays.

Preferably, monitoring the number of times calling the parameter to obtain the number of displays of the target picture in the webpage includes: monitoring the number of times calling the parameter within each first preset time period to obtain the number of displays of the target picture within each first preset time period.

Preferably, the target picture is an advertisement picture and the parameter includes advertisement positions, wherein there are multiple advertisement positions, and after monitoring the number of times calling the parameter to obtain the number of displays of the target picture in the webpage, the method further includes: acquiring the number of times calling a target advertisement position within a second preset time period, wherein the target advertisement position is an advertisement position in the multiple advertisement positions; and/or calculating a calling probability of the target advertisement position within the second preset time period.

Preferably, the parameter includes multiple delivery websites, wherein there are multiple delivery websites, and after monitoring the number of times calling the parameter to obtain the number of displays of the target picture in the webpage, the method further includes: acquiring the number of times calling a target delivery website within a third preset time period, wherein the target delivery website is a delivery website in the multiple delivery websites; and/or calculating a calling probability of the target delivery website within the third preset time period.

Preferably, the target picture is an advertisement picture and the parameter includes advertisement positions and delivery websites, wherein there are multiple delivery websites, each delivery website has multiple advertisement positions, and after monitoring the number of times calling the parameter to obtain the number of displays of the target picture in the webpage, the method further includes: acquiring the number of times of simultaneously calling a target delivery website and a target advertisement position within a fourth preset time period, wherein the target delivery website is a delivery website in the multiple delivery websites and the target advertisement position is an advertisement position of the target delivery website; and/or calculating a simultaneous calling probability of the target delivery website and the target advertisement position within the fourth preset time period.

In order to achieve the purpose, according to another aspect of the embodiment of the disclosure, a device for monitoring the number of displays of a picture is provided, which is configured to execute any method for monitoring the number of displays of picture provided by the abovementioned contents of the embodiment of the disclosure.

According to another aspect of the embodiment of the disclosure, a device method for monitoring the number of displays of is provided, which includes: an acquisition unit, configured to acquire a target picture; an addition unit, configured to add a parameter representative of display information of target picture; and a monitoring unit, configured to monitor the number of times calling the parameter to obtain the number of displays of the target picture in a webpage.

Preferably, the device further includes: a control unit, configured to control the parameter to generate an ID of the target picture, wherein the monitoring unit is configured to monitor the number of times calling the ID to obtain the number of displays of the target picture.

Preferably, the monitoring unit includes: a monitoring subunit, configured to monitor the number of times calling the parameter within each first preset time period to obtain the number of displays of the target picture within each first preset time period.

Preferably, the target picture is an advertisement picture and the parameter includes advertisement positions, wherein there are multiple advertisement positions, and the device further includes: a first acquisition unit, configured to acquire the number of times calling a target advertisement position within a second preset time period, wherein the target advertisement position is an advertisement position in the multiple advertisement positions; and/or a first calculation unit, configured to calculate a calling probability of the target advertisement position within the second preset time period.

Preferably, the parameter includes delivery websites, wherein there are multiple delivery websites, and the device further includes: a second acquisition unit, configured to acquire the number of times calling a target delivery website within a third preset time period, wherein the target delivery website is a delivery website in the multiple delivery websites; and/or a second calculation unit, configured to calculate a calling probability of the target delivery website within the third preset time period.

Preferably, the target picture is an advertisement picture and the parameter includes advertisement positions and delivery websites, wherein there are multiple delivery websites, each delivery website has multiple advertisement positions, and the device further includes: a third acquisition unit, configured to acquire the number of times of simultaneously calling a target delivery website and a target advertisement position within a fourth preset time period, the target delivery website is a delivery website in the multiple delivery websites and the target advertisement position is an advertisement position of the target delivery website; and/or a third calculation unit, configured to calculate a simultaneous calling probability of the target delivery website and the target advertisement position within the fourth preset time period.

According to the embodiment of the disclosure, the target picture is acquired; the parameter representative of display information of the target picture is added; and the number of times calling the parameter is monitored to obtain the number of displays of the target picture in the webpage. The parameter representative of the display information is added to the target picture, the parameter is associated with the target picture, delivery and display of the target picture may be represented by the parameter, the parameter may be called once every time when the target picture is delivered and displayed, and then the number of displays of the target picture may be represented by the number of times calling the parameter, so that the problem of incapability of monitoring an advertisement in a picture form in the existing technology is solved, and the effect of making a statistic on the number of displays of the advertisement picture is further achieved.

### BRIEF DESCRIPTION OF THE DRAWINGS

The drawings, forming a part of the disclosure, are adopted to provide further understanding of the disclosure. Schematic embodiments of the disclosure and description thereof are adopted to explain the disclosure and not intended to form improper limits to the disclosure. In the drawings:

FIG. 1 is a flowchart of a method for monitoring the number of displays of a picture according to an embodiment of the disclosure; and

FIG. 2 is a schematic diagram of a device for monitoring the number of displays of a picture according to an embodiment of the disclosure.

### DETAILED DESCRIPTION OF THE EMBODIMENTS

It is important to note that the embodiments in the disclosure and characteristics in the embodiments can be combined under the condition of no conflicts. The disclosure will be described below with reference to the drawings and the embodiments in detail.

The embodiment of the disclosure provides a method for monitoring the number of displays of a picture. The monitoring method is a method for monitoring the number of displays of an advertisement picture, that is, a picture in the embodiment of the disclosure refers to an advertisement picture. The method for monitoring the number of displays of a picture provided by the embodiment of the disclosure is specifically introduced below.

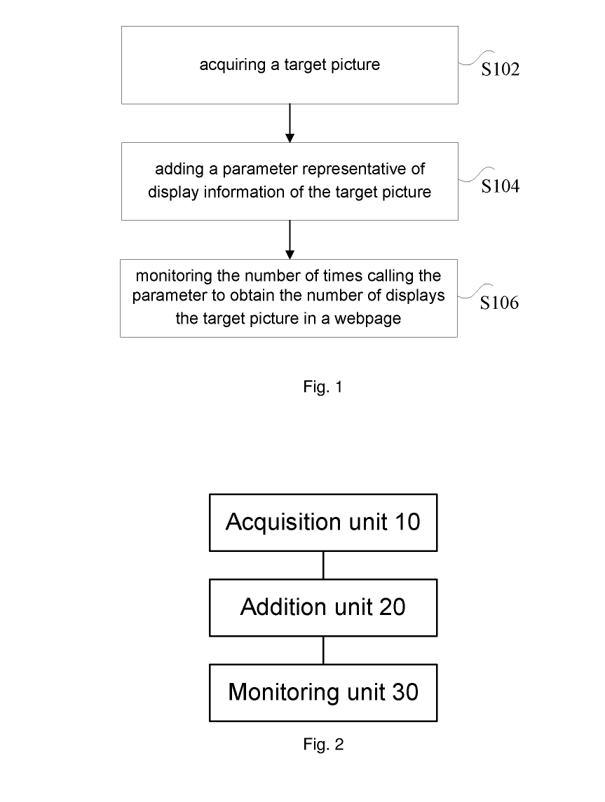

FIG. 1 is a flowchart of a method for monitoring the number of displays of a picture according to an embodiment of the disclosure, and as shown in FIG. 1, the method includes the following Step 102 to Step 106:

Step 102: acquiring a target picture, namely acquiring an advertisement picture, wherein the advertisement picture is a picture that an advertiser wants to display on a medium website, and any picture acquisition manner in the existing technology may be adopted for the acquisition of the target picture;

Step 104: adding a parameter representative of display information of target picture, wherein a parameter such as time and advertisement positions for displaying the advertisement picture is mainly added to form a schedule for displaying the advertisement picture specifically; and

Step 106: monitoring the number of times calling the parameter to obtain the number of displays of the target picture in a webpage, wherein the parameter may specifically be called once every time when the advertisement picture is loaded when the advertisement picture is delivered, and a display feedback may be sent to the number of displays monitoring server after such calling.

According to the method for monitoring the number of displays of a picture of the embodiment of the disclosure, the parameter representative of the display information is added to the target picture, the parameter is associated with the target picture, delivery and display of the target picture may be represented by the parameter, the parameter may be called once every time when the target picture is delivered and displayed, and then the number of displays of the target picture may be represented by the number of times calling the parameter, so that the problem of incapability of monitoring an advertisement in a picture form in the existing technology is solved, and the effect of making a statistic on the number of displays of the advertisement picture is further achieved.

In a preferred implementation mode, after adding the parameter representative of display information of the target picture, the monitoring method of the embodiment of the disclosure may also includes: controlling the parameter to generate an ID of the target picture, and correspondingly, the number of times calling the ID is monitored to obtain the number of displays of the target picture when the number displays is monitored.

The parameter is controlled to generate the ID of the target picture, so that the target picture may be represented by a unique ID, and accuracy of subsequent statistic on the number of displays is further ensured.

In a preferred implementation mode, monitoring the number of times calling the parameter to obtain the number of displays of the target picture in the embodiment of the disclosure mainly includes: monitoring the number of times calling the parameter within each first preset time period to obtain the number of displays of the target picture within each first preset time period. Wherein, the first preset time period may be time which is set according to a practical statistical requirement of the advertiser, and if the advertiser wants to know the number of displays of the target picture within every hour, the first preset time period may be an hour, and in the embodiment of the disclosure, the number of times calling the parameter within every hour is monitored.

Preferably, the parameter may include multiple advertisement positions for displaying the target picture, that is, there are multiple advertisement positions in the schedule of the advertisement picture, and after Step 106, the monitoring method of the embodiment of the disclosure further includes: acquiring the number of times calling a target advertisement position within a second preset time period, and/or calculating a calling probability of the target advertisement position within the second preset time period, wherein the target advertisement position is an advertisement position in the multiple advertisement positions, and the second preset time is also according to the practical statistical requirement of the advertiser to set.

In a preferred implementation mode, acquiring the number of times calling the target advertisement position within the second preset time period and/or calculating the calling probability of the target advertisement position within the second preset time period includes:

acquiring the number of times calling a certain target advertisement position within the second preset time period, and/or calculating a calling probability of the target advertisement position within the second preset time period, namely making a statistic on the number of displays and/or display frequency of the target picture at the target advertisement position within the second preset time period;

or acquiring total number of times calling some target advertisement positions within the second preset time period, and/or calculating a total calling probability of these target advertisement positions within the second preset time period, namely making a statistic on a total number of displays and/or display frequency of the target picture at these target advertisement positions within the second preset time period;

or acquiring the number of times calling some target advertisement positions within the second preset time period respectively, and/or calculating calling probabilities of these target advertisement positions within the second preset time period respectively, namely making statistics on the number of displays and/or display frequencies of the target picture at these target advertisement positions within the second preset time period respectively.

The number times calling the target advertisement position within the second preset time period is acquired, and/or the calling probability of the target advertisement position within the second preset time period is calculated, so that the display information of the target picture at the target advertisement position can be provided for the advertiser.

Preferably, the parameter may further include multiple delivery websites for displaying the target picture, that is, there are multiple delivery websites in the schedule of the advertisement picture, and after Step 106, the monitoring method of the embodiment of the disclosure further includes: acquiring the number of times calling a target delivery website within a third preset time period, and/or calculating a calling probability of the target delivery website within the third preset time period, wherein the target delivery website is a delivery website in the multiple delivery websites, and the third preset time period is also according to the practical statistical requirement of the advertiser to set.

In a preferred implementation mode, acquiring the number of times calling the target delivery website within the third preset time period and/or calculating the calling probability of the target delivery website within the third preset time period includes:

acquiring the number of times calling a certain target delivery website within the third preset time period, and/or calculating a calling probability of the target delivery website within the third preset time period, namely making a statistic on the number of displays and/or display frequency of the advertisement picture on the target delivery website within the third preset time period;

or acquiring total number of times calling some target delivery websites within the third preset time period, and/or calculating a total calling probability of these target delivery websites within the third preset time period, namely making a statistic on a total number of displays and/or display frequency of the advertisement picture on these target delivery websites within the third preset time period;

or acquiring the number of times calling some target delivery websites within the third preset time period respectively, and/or calculating calling probabilities of these target delivery websites within the third preset time period respectively, namely making statistics on the number of displays and/or display frequencies of the advertisement picture on these target delivery websites within the third preset time period respectively.

The number times calling the target delivery website within the third preset time period is acquired, and/or the calling probability of the target delivery website within the third preset time period is calculated, so that the display information of the target picture on the target delivery website can be provided or the advertiser.

Preferably, the parameter representative of display information of the target picture further includes advertisement positions and delivery websites, wherein there are multiple delivery websites, each delivery website has multiple advertisement positions, and after Step 106, the monitoring method of the embodiment of the disclosure may further include: acquiring the number of times of simultaneously calling a target delivery website and a target advertisement position within a fourth preset time period, and/or calculating a simultaneous calling probability of the target delivery website and the target advertisement position within the fourth preset time period, wherein the target delivery website is a delivery website in the multiple delivery websites, the target advertisement position is an advertisement position of the target delivery website, and the fourth preset time period is also according to the practical statistical requirement of the advertiser to set.

In a preferred implementation mode, acquiring the number of times of simultaneously calling the target delivery website and the target advertisement position within the fourth preset time period and/or calculating the simultaneous calling probability of the target delivery website and the target advertisement position within the fourth preset time period includes:

acquiring the number of times calling a certain target delivery website and a certain target advertisement position thereof within the fourth preset time period, and/or calculating a calling probability of the target delivery website and the target advertisement position thereof within the fourth preset time period, namely making a statistic on a number of displays and/or display frequency of the advertisement picture at the target advertisement position of the target delivery website within the fourth preset time period;

or acquiring total the number of times calling a certain target delivery website and some target advertisement positions thereof within the fourth preset time period, and/or calculating a total calling probability of the target delivery website and these target advertisement positions thereof within the fourth preset time period, namely making a statistic on a total number of displays and/or display frequency of the advertisement picture at these target advertisement positions of the target delivery website within the fourth preset time period;

or acquiring the number of times calling a certain target delivery website and some target advertisement positions thereof within the fourth preset time period respectively, and/or calculating calling probabilities of the target delivery website and these target advertisement positions thereof within the fourth preset time period respectively, namely making statistics on the number of displays and/or display frequencies of the advertisement picture at these target advertisement positions of the target delivery website within the fourth preset time period respectively;

or acquiring total number of times calling some target delivery websites and a certain target advertisement position of each target delivery website within the fourth preset time period, and/or calculating a total calling probability of these target delivery websites and the target advertisement position of each target delivery website within the fourth preset time period, namely making a statistic on a total number of displays and/or display frequency of the advertisement picture at the same target advertisement position of these target delivery websites within the fourth preset time period;

or acquiring total number of times calling some target delivery websites and some target advertisement positions of each target delivery website within the fourth preset time period, and/or calculating a total calling probability of these target delivery websites and the target advertisement positions of each target delivery website within the fourth preset time period, namely making a statistic on a total number of displays and/or display frequency of the advertisement picture at these target advertisement positions of these target delivery websites within the fourth preset time period;

or acquiring the number of times calling some target delivery websites and some target advertisement positions of each target delivery website within the fourth preset time period respectively, and/or calculating calling probabilities of these target delivery websites and these target advertisement positions of each target delivery website within the fourth preset time period respectively, namely making statistics on the number of displays and/or display frequencies of the advertisement picture at these target advertisement positions of these target delivery websites within the fourth preset time period respectively.

The number of times of simultaneously calling the target delivery website and the target advertisement position within the fourth preset time period is acquired, and/or the simultaneous calling probability of the target delivery website and the target advertisement position within the fourth preset time period is calculated, so that the display information of the advertisement picture at the target advertisement position of the target delivery website can be provided for the advertiser.

The embodiment of the disclosure further provides a device for monitoring the number of displays of a picture, which may be configured to execute any method for monitoring the number of displays of a picture provided by the abovementioned contents of the embodiment of the disclosure. The device for monitoring the number of displays of a picture provided by the embodiment of the disclosure is specifically introduced below.

FIG. 2 is a schematic diagram of a device for monitoring the number of displays of a picture according to an embodiment of the disclosure, and as shown in FIG. 2, the device for monitoring the number of displays of a picture of the embodiment mainly includes an acquisition unit 10, an addition unit 20 and a monitoring unit 30.

In a preferred implementation mode, the acquisition unit 10 is configured to acquire a target picture, namely acquire an advertisement picture, wherein the advertisement picture is a picture that an advertiser wants to display on a medium website, and any picture acquisition manner in the existing technology may be adopted for the acquisition of the target picture. The addition unit 20 is configured to add a parameter representative of display information of target picture, wherein a parameter such as time and advertisement positions for displaying the advertisement picture is mainly added to form a schedule for displaying the advertisement picture. The monitoring unit 30 is configured to monitor the number of times calling the parameter to obtain the number of displays of the target picture in a webpage, wherein the parameter may be called once every time when the advertisement picture is loaded when the advertisement picture is delivered, and a display feedback may be sent to the number of displays monitoring server after such calling.

According to the device for monitoring the number of displays of a picture of the embodiment of the disclosure, the addition unit adds the parameter representative of the display information to the target picture, the parameter is associated with the target picture, delivery and display of the target picture may be represented by the parameter, the parameter may be called once every time when the target picture is delivered and displayed, and then the monitoring unit may monitor the number of times calling the parameter to represent the number of displays of the target picture, so that the problem of incapability of monitoring an advertisement in a picture form in the existing technology is solved, and the effect of making a statistic on the number of displays of the advertisement picture is further achieved.

In a preferred implementation mode, the monitoring device of the embodiment of the disclosure further includes a control unit, the control unit controls the parameter to generate an ID of the target picture after the parameter representative of display information of the target picture is added, and correspondingly, monitoring unit monitors the number of times calling the ID to obtain number of displays.

The parameter is controlled to generate the ID of the target picture, so that the target picture may be represented by a unique ID, and accuracy of subsequent statistic on the number of displays is further ensured.

In a preferred implementation mode, the monitoring unit 30 mainly includes a monitoring subunit, and the monitoring subunit is configured to monitor number of times calling the parameter within each first preset time period to obtain the number of displays of the target picture within each first preset time period. Wherein, the first preset time period may be time which is set according to a practical statistical requirement of the advertiser, and if the advertiser wants to know the number of displays of the target picture within every hour, the first preset time period may be an hour, and in the embodiment of the disclosure, the number of times calling the parameter within every hour is monitored.

Preferably, the parameter representative of display information of the target picture includes multiple advertisement positions for displaying the target picture, that is, there are multiple advertisement positions in the schedule of the advertisement picture, and the monitoring device of the embodiment of the disclosure further includes a first acquisition unit and/or a first calculation unit, wherein the first acquisition unit is configured to acquire the number of times calling a target advertisement position within a second preset time period, the first calculation unit is configured to calculate a calling probability of the target advertisement position within the second preset time period, the target advertisement position is an advertisement position in the multiple advertisement positions, and the second preset time period is also time which is set according to the practical statistical requirement of the advertiser.

In a preferred implementation mode, acquiring the number of times calling the target advertisement position within the second preset time period includes:

acquiring the number of times calling a certain target advertisement position within the second preset time period, namely making a statistic on the number of displays of the advertisement picture at the target advertisement position within the second preset time period;

or acquiring total number of times calling some target advertisement positions within the second preset time period, namely making a statistic on a total number of displays of the advertisement picture at these target advertisement positions within the second preset time period;

or acquiring the number of times calling some target advertisement positions within the second preset time period respectively, namely making statistics on the number of displays of the advertisement picture at these target advertisement positions within the second preset time period respectively.

Correspondingly, calculating the calling probability of the target advertisement position within the second preset time period includes:

calculating a calling probability of a certain target advertisement position within the second preset time period, namely making a statistic on a display frequency of the advertisement picture at the target advertisement position within the second preset time period;

or calculating a total calling probability of some target advertisement positions within the second preset time period, namely making a statistic on a total display frequency of the advertisement picture at these target advertisement positions within the second preset time period;

or calculating calling probabilities of some target advertisement positions within the second preset time period respectively, namely making statistics on display frequencies of the advertisement picture at these target advertisement positions within the second preset time period respectively.

Due to the arrangement of the first acquisition unit and/or the first calculation unit, the display information of the advertisement picture at the target advertisement position can be provided for the advertiser.

Preferably, the parameter representative of display information of the target picture may further include multiple delivery websites for displaying the target picture, that is, there are multiple delivery websites in the schedule of the advertisement picture, and the monitoring device of the embodiment of the disclosure includes a second acquisition unit and/or a second calculation unit, wherein the second acquisition unit is configured to acquire the number of times calling a target delivery website within a third preset time period, the second calculation unit is configured to calculate a calling probability of the target delivery website within the third preset time period, the target delivery website is a delivery website in the multiple delivery websites, and the third preset time period is also time which is set according to the practical statistical requirement of the advertiser.

In a preferred implementation mode, acquiring the number of times calling the target delivery website within the third preset time period includes:

acquiring the number of times calling a certain target delivery website within the third preset time period, namely making a statistic on the number of displays of the advertisement picture on the target delivery website within the third preset time period;

or acquiring total number of times calling some target delivery websites within the third preset time period, namely making a statistic on a total number of displays of the advertisement picture on these target delivery websites within the third preset time period;

or acquiring the number of times calling some target delivery websites within the third preset time period respectively, namely making statistics on the number of displays of the advertisement picture on these target delivery websites within the third preset time period respectively.

Correspondingly, calculating the calling probability of the target delivery website within the third preset time period includes:

calculating a calling probability of a target delivery website within the third preset time period, namely making a statistic on a display frequency of the advertisement picture on the target delivery website within the third preset time period;

or calculating a total calling probability of some target delivery websites within the third preset time period, namely making a statistic on a total display frequency of the advertisement picture on these target delivery websites within the third preset time period;

or calculating calling probabilities of some target delivery websites within the third preset time period respectively, namely making statistics on display frequencies of the advertisement picture on these target delivery websites within the third preset time period respectively.

Due to the arrangement of the second acquisition unit and/or the second calculation unit, the display information of the target picture on the target delivery website can be provided or the advertiser.

Preferably, the parameter representative of display information of the target picture further includes advertisement positions and delivery websites, wherein there are multiple delivery websites, each delivery website has multiple advertisement positions, and the monitoring device of the embodiment of the disclosure includes a third acquisition unit and/or a third calculation unit, wherein the third acquisition unit is configured to acquire the number of times of simultaneously calling a target delivery website and a target advertisement position within a fourth preset time period, the third calculation unit is configured to calculate a simultaneous calling probability of the target delivery website and the target advertisement position within the fourth preset time period, the target delivery website is a delivery website in the multiple delivery websites, the target advertisement position is an advertisement position of the target delivery website, and the fourth preset time period is also time which is set according to the practical statistical requirement of the advertiser.

In a preferred implementation mode, acquiring the simultaneous number of times calling the target delivery website and the target advertisement position within the fourth preset time period includes:

acquiring the number of times calling a certain target delivery website and a certain target advertisement position thereof within the fourth preset time period, namely making a statistic on the number of displays of the advertisement picture at the target advertisement position of the target delivery website within the fourth preset time period;

or acquiring total the number of times calling a certain target delivery website and some target advertisement positions thereof within the fourth preset time period, namely making a statistic on a total number of displays of the advertisement picture at these target advertisement positions of the target delivery website within the fourth preset time period;

or acquiring the number of times calling a certain target delivery website and some target advertisement positions thereof within the fourth preset time period respectively, namely making statistics on the number of displays of the advertisement picture at these target advertisement positions of the target delivery website within the fourth preset time period respectively;

or acquiring total number of times calling some target delivery websites and a certain target advertisement position of each target delivery website within the fourth preset time period, namely making a statistic on a total number of displays of the advertisement picture at the same target advertisement position of these target delivery websites within the fourth preset time period;

or acquiring total number of times calling some target delivery websites and some target advertisement positions of each target delivery website within the fourth preset time period, namely making a statistic on a total number of displays of the advertisement picture at these target advertisement positions of these target delivery websites within the fourth preset time period;

or acquiring number of times calling some target delivery websites and some target advertisement positions of each target delivery website within the fourth preset time period respectively, namely making statistics on the number of displays of the advertisement picture at these target advertisement positions of these target delivery websites within the fourth preset time period respectively.

Correspondingly, calculating the simultaneous calling probability of the target delivery website and the target advertisement position within the fourth preset time period includes:

calculating a calling probability of a certain target delivery website and a certain target advertisement position thereof within the fourth preset time period, namely making a statistic on a display frequency of the advertisement picture at the target advertisement position of the target delivery website within the fourth preset time period;

or calculating a total calling probability of a certain target delivery website and some target advertisement positions thereof within the fourth preset time period, namely making a statistic on a total display frequency of the advertisement picture at these target advertisement positions of the target delivery website within the fourth preset time period;

or calculating calling probabilities of a certain target delivery website and some target advertisement positions thereof within the fourth preset time period respectively, namely making statistics on display frequencies of the advertisement picture at these target advertisement positions of the target delivery website within the fourth preset time period respectively;

or calculating a total calling probability of some target delivery websites and a certain target advertisement position of each target delivery website within the fourth preset time period, namely making a statistic on a total display frequency of the advertisement picture at the same target advertisement position of these target delivery websites within the fourth preset time period;

or calculating a total calling probability of some target delivery websites and some target advertisement positions of each target delivery website within the fourth preset time period, namely making a statistic on a total display frequency of the advertisement picture at these target advertisement positions of these target delivery websites within the fourth preset time period;

or calculating calling probabilities of some target delivery websites and some target advertisement positions of each target delivery website within the fourth preset time period respectively, namely making statistics on display frequencies of the advertisement picture at these target advertisement positions of these target delivery websites within the fourth preset time period respectively.

Due to the arrangement of the third acquisition unit and/or the third calculation unit, the display information of the advertisement picture at the target advertisement position of the target delivery website can be provided for the advertiser.

From the above, it can be seen that the effect of making the statistic on the number of displays of the advertisement picture is achieved by the disclosure.

It is important to note that the steps shown in the flowchart of the drawing may be executed in a computer system, such as a group of computers, capable of executing instructions, and moreover, although there is shown a logic sequence in the flowchart, the shown or described steps may be executed in a sequence different from the sequence described here under a certain condition.

Obviously, those skilled in the art should know that each module or step of the disclosure may be implemented by a universal computing device, and the modules or steps may be concentrated on a single computing device or distributed on a network formed by multiple computing devices, and may optionally be implemented by program codes executable for the computing devices, so that the modules or steps may be stored in a storage device for execution with the computing devices, or may form each integrated circuit module, or multiple modules or steps therein may form a single integrated circuit module for implementation. As a consequence, the disclosure is not limited to any specific hardware and software combination.

The above is only the preferred embodiment of the disclosure and not intended to limit the disclosure, and for those skilled in the art, the disclosure may have various modifications and variations. Any modifications, equivalent replacements, improvements and the like within the spirit and principle of the disclosure shall fall within the scope of protection of the disclosure.

1. A method for monitoring the number of displays of a picture, comprising:
acquiring a target picture;
adding a parameter representative of display information of the target picture; and
monitoring the number of times calling the parameter to obtain the number of displays the target picture in a webpage.

2. The monitoring method as claimed in claim 1, wherein after adding the parameter representative of the display information of the target picture, the method further comprises:
controlling the parameter to generate an Identifier (ID) of the target picture,
wherein monitoring the number of times calling the parameter to obtain the number of displays of the target picture in the webpage comprises: monitoring the number of times calling the ID to obtain the number of displays of the target picture.

3. The monitoring method as claimed in claim 1, wherein monitoring the number of times calling the parameter to obtain the number of displays of the target picture in the webpage comprises:
monitoring the number of times calling the parameter within each first preset time period to obtain the number of displays of the target picture within each first preset time period.

4. The monitoring method as claimed in claim 1, wherein the target picture is an advertisement picture and the parameter comprises advertisement positions, wherein there are multiple advertisement positions, and after monitoring the number of times calling the parameter to obtain the number of displays the target picture in a webpage, the method further comprises:
acquiring the number of times calling a target advertisement position within a second preset time period, wherein the target advertisement position is an advertisement position in the multiple advertisement positions; and/or
calculating a calling probability of the target advertisement position within the second preset time period.

5. The monitoring method as claimed in claim 1, wherein the parameter comprises multiple delivery websites, wherein there are multiple delivery websites, and after monitoring the number of times calling the parameter to obtain the number of displays of the target picture in the webpage, the method further comprises
acquiring the number of times calling a target delivery website within a third preset time period, wherein the target delivery website is a delivery website in the multiple delivery websites; and/or
calculating a calling probability of the target delivery website within the third preset time period.

6. The monitoring method as claimed in claim 1, wherein the target picture is an advertisement picture and the parameter comprises multiple advertisement positions and delivery websites, wherein there are multiple delivery websites, each delivery website has multiple advertisement positions, and after monitoring the number of times calling the parameter to obtain the number of displays the target picture in a webpage, the method further comprises:
acquiring the number of times of simultaneously calling a target delivery website and a target advertisement position within a fourth preset time period, wherein the target delivery website is a delivery website in the multiple delivery websites and the target advertisement position is an advertisement position of the target delivery website; and/or
calculating a simultaneous calling probability of the target delivery website and the target advertisement position within the fourth preset time period.

7. A device for monitoring the number of displays of a picture, comprising:
an acquisition unit, configured to acquire a target picture;
an addition unit, configured to add a parameter representative of display information of target picture; and
a monitoring unit, configured to monitor the number of times calling the parameter to obtain the number of displays of the target picture in a webpage.

8. The monitoring device as claimed in claim 7, the device further comprises:
a control unit, configured to control the parameter to generate an Identifier (ID) of the target picture,
wherein the monitoring unit is configured to monitor the number of times calling the ID to obtain the number of displays of the target picture.

9. The monitoring device as claimed in claim 7, wherein the monitoring unit comprises:
a monitoring subunit, configured to monitor the number of times calling the parameter within each first preset time period to obtain the number of displays of the target picture within each first preset time period.

10. The monitoring device as claimed in claim 7, wherein the target picture is an advertisement picture and the parameter comprises advertisement positions, wherein there are multiple advertisement positions, the device further comprises:
a first acquisition unit, configured to acquire the number of times calling a target advertisement position within a second preset time period, wherein the target advertisement position is an advertisement position in the multiple advertisement positions; and/or
a first calculation unit, configured to calculate a calling probability of the target advertisement position within the second preset time period.

11. The monitoring device as claimed in claim 7, wherein the parameter comprises delivery websites, wherein there are multiple delivery websites, the device further comprises:
a second acquisition unit, configured to acquire the number of times calling a target delivery website within a third preset time period, wherein the target delivery website is a delivery website in the multiple delivery websites; and/or
a second calculation unit, configured to calculate a calling probability of the target delivery website within the third preset time period.

12. The monitoring device as claimed in claim 7, wherein the target picture is an advertisement picture and the parameter comprises advertisement positions and delivery websites, wherein there are multiple delivery websites, each delivery website has multiple advertisement positions, the device further comprises:
a third acquisition unit, configured to acquire the number of times of simultaneously calling a target delivery website and a target advertisement position within a fourth preset time period, wherein the target delivery website is a delivery website in the multiple delivery websites and the target advertisement position is an advertisement position of the target delivery website; and/or
a third calculation unit, configured to calculate a simultaneous calling probability of the target delivery website and the target advertisement position within the fourth preset time period.

13. The monitoring method as claimed in claim 4, wherein the parameter comprises multiple delivery websites, wherein there are multiple delivery websites, and after monitoring the number of times calling the parameter to obtain the number of displays of the target picture in the webpage, the method further comprises
acquiring the number of times calling a target delivery website within a third preset time period, wherein the target delivery website is a delivery website in the multiple delivery websites; and/or
calculating a calling probability of the target delivery website within the third preset time period.

14. The monitoring device as claimed in claim 10, wherein the parameter comprises delivery websites, wherein there are multiple delivery websites, the device further comprises:
a second acquisition unit, configured to acquire the number of times calling a target delivery website within a third preset time period, wherein the target delivery website is a delivery website in the multiple delivery websites; and/or
a second calculation unit, configured to calculate a calling probability of the target delivery website within the third preset time period.
